(19) United States
(12) Patent Application Publication
(10) Pub. No.: US 2004/0011732 A1
(43) Pub. Date: Jan. 22, 2004

(54) Aquarium filtering plate

(76) Inventor: Jacqueline Babbitt, Flint, MI (US)

Correspondence Address: Jacqueline Babbitt, 6305 Cecil Dr., Flint, MI, 48505, US

(21) Appl. No.: 10/198,928

(22) Filed: Jul. 19, 2002

(51) Int. Cl. B01D 29/00

(52) U.S. Cl. 210/489

(57) ABSTRACT

This is an under water filtering plate which houses a filtering pad to catch debris in the aquarium.

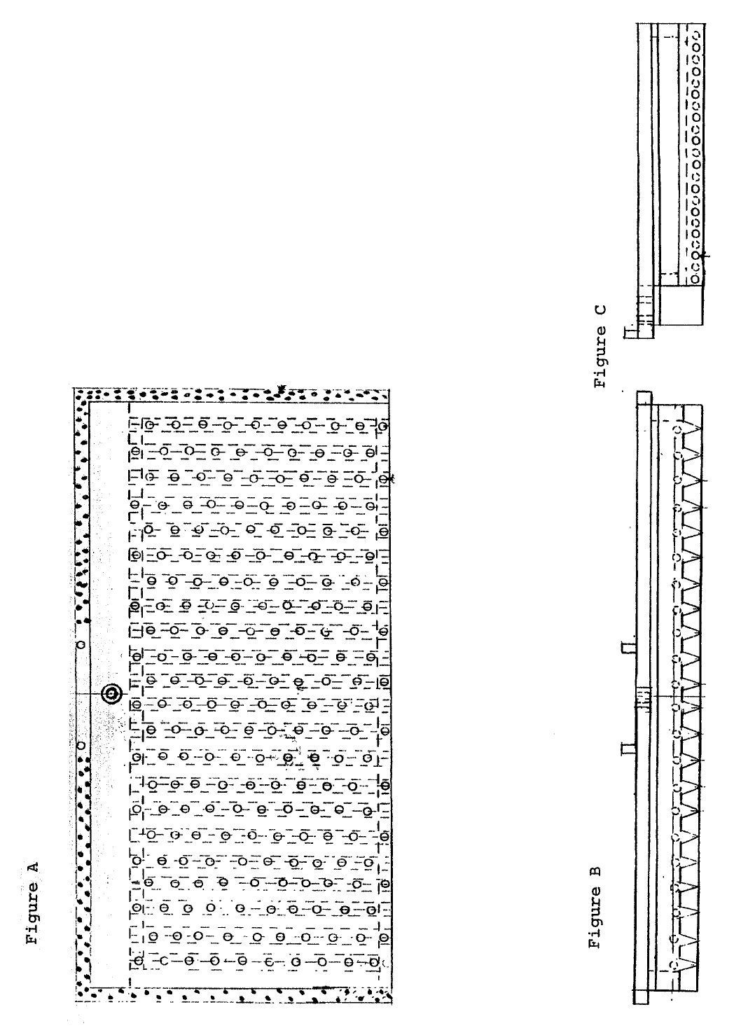

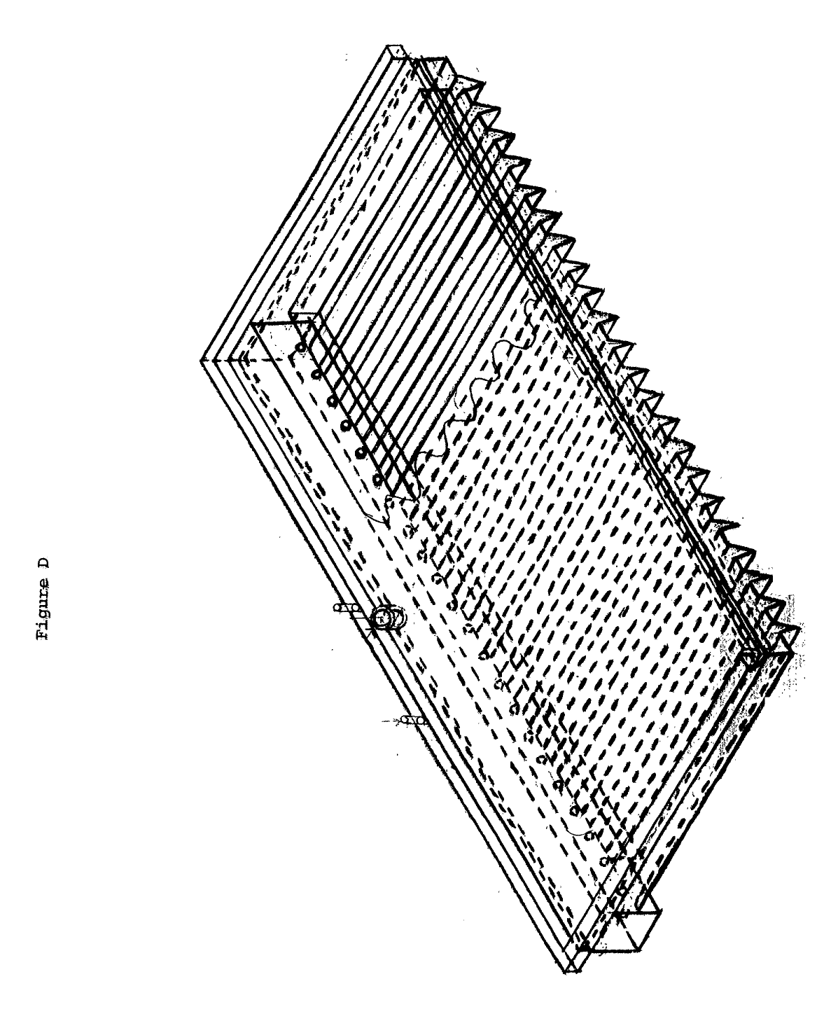

### STATEMENT

The aquarium filtering plate works in conjuction with an aquarium filtering canister as the primary or secondary filter.

When the plate is attached to a filtering canisters water inlet (water which is being pulled into the canister for filtering) it acts as the primary filter water is pulled through THE filtering plate across a filtering pad which catches debris in the aquariums water before it is drown into the canister where it is refiltered and returned to the tank.

When the filtering plate is attached to a filtering canister water outlet (water filtered returning to the aquarium) it acts as a secondary filter water is pushed through the filtering plate across a filtering pad which catches the debris not filtered out by the filtering canister.

### BACKGROUND

Until now aquarium filtering devices have been designed to work with the movement of the aquatic life in the aquarium filtering only the debris that has been moved by the aquatic life to the immediate area of the filtering devices waste receptacle which is normally attached to the top of the aquarium and reaching down midway or close to the bottom.

The aquarium filtering plate when attached to a aquarium filtering canister aids in the filtering process in one of two ways as a primary filter it has the capability to filter out waste particles all across the bottom of the aquarium independent of the aquatic movement leaving only minute particles to be filtered by the filtering canister.

When the aquarium filtering plate is used as a secondary filter it in turn works with the air pump to clean the aquarium by forcing debris to the top of the aquarium surface where it is then caught by the filtering canister. IN this capacity the filtering plate cleans the debris that is not filtered out by the canister.

Aquarium plates that are being offered in todays market are only ornamental usually they hold some type of detoxifying minerals that are suppose to keep the balance of the water in the aquarium. The down fall is that plate traps waste underneath creating a hazardous condition.

This aquarium plate has flow holes in which waste is pulled into the plate and the waste is trapped by a filtering pad which can be changed.

### PROTOTYPE BASED SUMMARY

This design is a under water filtering device which works in conjuction with a filtering canister. It works on the filtering canisters inlet or outlet cleaning the aquarium by pushing or pulling water and debris across a filtering pad which catches the waste in the water.

### DESCRIPTION OF DRAWINGS

FIG.: A Top view showing air holes and flow holes

FIG.: B Front view showing air and pump connections.

FIG.: C Side view

FIG.: D 3/D View

### DESCRIPTION OF EMBODIMENT

(Inlet Position)

Reference:

Page 14 FIG. (1) a filtering canister connection which connects to a filtering canisters inlet which draws water and waste through FIGS. (2) and (3) flow holes which deposit into FIG. (4) chambers which equalize the pressure on the plate while allowing waste to be trapped by FIG. (5) a filtering pad compartment. Once filtered through the fiber the water flows through FIG. (6) the flow holes leading to the reservoir into FIG. (7) the reservoir where it is then pulled into the filtering canister for refiltering. FIG. (8) is a air line attachment which supplies oxygen into the aquarium through FIG. (9) air holes when attached to a air pump.

### DESCRIPTION OF EMBODIMENT

(Outlet Position)

Reference:

Page 14 FIG. (1) a filtering canister connection which connects to a filtering canisters outlet water is pushed out of the filtering canister into FIG. (7) the reservoir through FIG. (6) the reservoirs flow holes across FIG. (5) the filtering pad compartment which catches the waste into FIG. (4) water chambers and out through FIGS. (2) and (3)

### DESCRIPTION OF EMBODIMENT

(Outlet Position)

Continued flow holes which work along with FIG. (9) air holes which are supplied by FIG. (8) air line connections when attached to a air pump working together using air and water pressure to circulate debris in the aquarium keeping it moving so it can be filtered out by the filtering canister.

1. Under water filtering plate working in conjuction with a filtering canister.

2. Filtering plate which works on a canisters inlet or outlet

3. Under water self contained filter plate.
